(19) United States
(12) Patent Application Publication
(10) Pub. No.: US 2025/0059831 A1
(43) Pub. Date: Feb. 20, 2025

(54) ROLLER BLIND FRICTION-CREATING ASSEMBLY AND ONE-WAY BEARING FOR THE SAME

(71) Applicant: 7912854 CANADA INC., Terrebonne (CA)

(72) Inventor: AUGUSTIN ARCHAMBAULT, Stoke (CA)

(21) Appl. No.: 18/720,590

(22) PCT Filed: Dec. 16, 2022
(86) PCT No.: PCT/CA2022/051849

§ 371 Date: Jun. 14, 2024

Related U.S. Application Data
(60) Provisional application No. 63/265,517, filed on Dec. 16, 2021.

(51) Int. Cl. E06B 9/90; E06B 9/50

(52) U.S. Cl. CPC E06B 9/90; E06B 9/50

(57) ABSTRACT

The present disclosure concerns a roller blind friction-creating assembly comprising a support-mounting shaft system having a shaft axis and being fixedly mountable to a support: a tube-coupling bearing having a first portion angularly couplable with a roller blind tube and a second portion rotatably mounted onto the support-mounting shaft system, the first and second portions being rotatable together around the support-mounting shaft system in a first rotating direction upon rotation of the roller blind tube in one of winding and unwinding directions; and a friction-creating system mounted to the support-mounting shaft system and having at least one friction-creating surface contacting the tube-coupling bearing: wherein the friction-creating system provides a friction couple to the tube-coupling bearing upon rotation of the tube-coupling bearing in said first rotating direction. It also concerns a one-way bearing.

### PRIOR APPLICATION

The present application claims priority from U.S. provisional patent application No. 63/265,517, filed on Dec. 16, 2021, and entitled “ROLLER BLIND FRICTION-CREATING ASSEMBLY AND ONE-WAY BEARING FOR THE SAME”, the disclosure of which being hereby incorporated by reference in its entirety.

### TECHNICAL FIELD

The technical field relates to friction-creating assemblies, and more particularly to adjustable roller blind friction-creating assemblies for roller blind systems, and to one-way bearings, more particularly to one-way bearings for roller blind friction-creating assemblies.

### BACKGROUND

Roller blinds are known that are rolled onto a roller blind tube and are configurable into extended and retracted configurations upon rotation of the roller blind tube. Roller blind systems comprise an actuator and a roller blind mechanism configured to configure the roller blind from one of the extended and retracted configurations to the other—or to any other configuration between the extended and retracted configurations—upon actuation of the actuator. In some circumstances, it might be required to provide a friction couple to the roller blind tube when the roller blind tube is rotated in at least one direction, for instance to compensate for a lack of balance of the roller blind tube and/or to maintain the roller blind at a predetermined position between the extended and retracted configurations.

In view of the above, there is a need for a roller blind friction-creating assembly which would be able to overcome or at least minimize some of the above-discussed prior art concerns.

### BRIEF SUMMARY

It is therefore an aim of the present invention to at least partially address the above-mentioned issues.

According to a general aspect, there is provided a one-way bearing having a central axis, comprising: an inner race comprising an outer surface; an outer race surrounding, considered in a plane transversal to the central axis, at least partially the inner race and comprising an inner surface, at least a portion of the inner surface being radially spaced apart from the outer surface of the inner race to define at least one coupling member-receiving chamber therebetween; and at least one unidirectional coupling member provided in said at least one coupling member-receiving chamber; wherein the outer surface of the inner race at least partially forms first and second tangential wall portions at least partially delimiting said at least one coupling member-receiving chamber; wherein said at least one unidirectional coupling member engages with the inner surface of the outer race when the outer race is rotated about the central axis in a first direction, thus abutting one of the first and second tangential wall portions and rotating the inner race together with the outer race in the first direction; and wherein said at least one unidirectional coupling member slides along the inner surface of the outer race when the outer race rotates about the central axis in a second direction opposed to the first direction, thus allowing a free rotation of the outer race with respect to the inner race, said at least one unidirectional coupling member having an outer surface selectively engageable with the inner surface of the outer race when the outer race is rotated about the central axis.

In some embodiments, a plurality of indentations are formed along an entirety of a periphery of the inner surface of the outer race. In some embodiments, said at least one unidirectional coupling member comprises an inner race-facing side and an opposed outer race-facing side forming at least partially the outer surface. In some embodiments, a profile of the outer race-facing side of said at least one unidirectional coupling member corresponds substantially to a profile of the inner surface of the outer race. In some embodiments, the outer surface of the inner race forms an actuating slope extending between the first and second tangential wall portions. In some embodiments, the actuating slope is inclined relative to a tangential direction defined at a point equidistant from inner end portions of the first and second tangential wall portions. In some embodiments, a profile of the inner race-facing side of said at least one unidirectional coupling member corresponds substantially to the bearing-actuating slope.

In some embodiments, said at least one unidirectional coupling member has a substantially trapezoidal cross-section, considered in a plane transversal to the central axis. In some embodiments, a plurality of coupling-member receiving chambers are defined between the inner surface of the outer race and the outer surface of the inner race. In some embodiments, the plurality of coupling-member receiving chambers are regularly distributed along a periphery of the outer surface of the inner race. In some embodiments, four coupling-member receiving chambers are defined between the inner surface of the outer race and the outer surface of the inner race, the one-way bearing further comprising four unidirectional coupling members provided respectively in the four coupling-member receiving chambers. In some embodiments, the inner race comprises first and second inner race members engaged with each other and axially delimiting said at least one coupling member-receiving chamber. In some embodiments, the first and second inner race members are removably mounted to each other, said at least one unidirectional coupling member being encapsulated therebetween. In some embodiments, the outer race is at least partially sandwiched between the first and second inner race members.

According to another general aspect, there is provided a roller blind friction-creating assembly for a roller blind system mountable to a roller blind support and comprising a roller blind tube rotatable about a tube longitudinal axis into opposed winding and unwinding directions, the friction-creating assembly comprising: a support-mounting shaft system having a shaft axis and being fixedly mountable to the roller blind support; a one-way bearing according to the present disclosure, the outer race being angularly couplable with the roller blind tube and the inner race being rotatably mounted onto the support-mounting shaft system, the outer and inner races being rotatable together around the support-mounting shaft system in the first direction about the shaft axis upon rotation of the roller blind tube in one of the winding and unwinding directions; and a friction-creating system mounted to the support-mounting shaft system and having at least one friction-creating surface contacting the one-way bearing; wherein the friction-creating system provides a friction couple to the one-way bearing via said at least one friction-creating surface upon rotation of the inner and outer races of the one-way bearing in said first direction.

In some embodiments, the friction-creating system comprises a biasing member engaged with said support-mounting shaft system and with said at least one friction-creating surface to bias said at least one friction-creating surface towards the one-way bearing. In some embodiments, the friction-creating system further comprises a friction adjuster engaged with the biasing member to adjust a value of a biasing force applied by the biasing member onto said at least one friction-creating surface. In some embodiments, the friction adjuster is mountable onto the support-mounting shaft in at least two longitudinal positions, thus allowing the biasing member to provide at least two distinct biasing force intensities. In some embodiments, a plurality of biasing member-engaging portions are formed on the support-mounting shaft system, the biasing member-engaging portions being axially spaced apart from each other, the biasing member being selectively engageable with each one of said plurality of biasing member-engaging portions. In some embodiments, the biasing member comprises a compression spring. In some embodiments, the assembly comprises at least one friction-creating pad forming said at least one friction-creating surface and angularly coupled to the support-mounting shaft system. In some embodiments, said at least one friction-creating pad is at least partially formed of rubber. In some embodiments, the assembly comprises first and second friction-creating pads forming respectively first and second friction-creating surfaces, the one-way bearing being arranged axially between the first and second friction-creating pads. In some embodiments, the inner race comprises first and second inner race members engaged with each other and axially delimiting said at least one coupling member-receiving chamber, the first and second friction-creating pads contacting respectively the first and second inner race members. In some embodiments, the first and second inner race members are removably mounted to each other, said at least one unidirectional coupling member being encapsulated therebetween. In some embodiments, the outer race is at least partially sandwiched between the first and second inner race members. In some embodiments, the outer race of the one-way bearing is rotatable about the support-mounting shaft system and the inner race of the one-way bearing in a second direction opposed to the first direction about the shaft axis upon rotation of the roller blind in said other one of the winding and unwinding directions. In some embodiments, said at least one friction-creating surface is at least one of radially and axially spaced apart from the outer race of the one-way bearing. In some embodiments, the outer race further comprises flexible tube-engaging tongues protruding outwardly from an outer surface thereof that are dimensioned and shaped so that the one-way bearing substantially conforms to an inner surface of the roller blind tube when in use.

According to another general aspect, there is provided a roller blind friction-creating assembly for a roller blind system mountable to a roller blind support and comprising a roller blind tube rotatable about a tube longitudinal axis into opposed winding and unwinding directions, the friction-creating assembly comprising: a support-mounting shaft system having a shaft axis and being fixedly mountable to the roller blind support; a tube-coupling bearing having a first portion angularly couplable with the roller blind tube and a second portion rotatably mounted onto the support-mounting shaft system, the first and second portions being rotatable together around the support-mounting shaft system in a first rotating direction about the shaft axis upon rotation of the roller blind tube in one of the winding and unwinding directions; and a friction-creating system mounted to the support-mounting shaft system and having at least one friction-creating surface contacting the tube-coupling bearing; wherein the friction-creating system provides a friction couple to the tube-coupling bearing via said at least one friction-creating surface upon rotation of the first and second portions of the tube-coupling bearing in said first rotating direction.

In some embodiments, the friction-creating system comprises a biasing member engaged with said support-mounting shaft system and with said at least one friction-creating surface to bias said at least one friction-creating surface towards the tube-coupling bearing. In some embodiments, the friction-creating system further comprises a friction adjuster engaged with the biasing member to adjust a value of a biasing force applied by the biasing member onto said at least one friction-creating surface. In some embodiments, the friction adjuster is mountable onto the support-mounting shaft in at least two longitudinal positions, thus allowing the biasing member to provide at least two distinct biasing force intensities. In some embodiments, a plurality of biasing member-engaging portions are formed on the support-mounting shaft system, the biasing member-engaging portions being axially spaced apart from each other, the biasing member being selectively engageable with each one of said plurality of biasing member-engaging portions. In some embodiments, the biasing member comprises a compression spring. In some embodiments, the assembly comprises at least one first friction-creating pad forming said at least one friction-creating surface and angularly coupled to the support-mounting shaft system. In some embodiments, said at least one friction-creating pad is at least partially formed of rubber. In some embodiments, the assembly comprises first and second friction-creating pads forming respectively first and second friction-creating surfaces, the tube-coupling bearing being arranged axially between the first and second friction-creating pads. In some embodiments, the tube-coupling bearing is a bidirectional bearing, the first and second portions being rotatable together about the shaft axis in opposed first and second rotating directions upon rotation of the roller blind tube respectively in the winding and unwinding directions. In some embodiments, the tube-coupling bearing is a one-way tube-coupling bearing, the first portion of the tube-coupling bearing being rotated about both the support-mounting shaft system and the second portion of the tube-coupling bearing in a second rotating direction about the shaft axis upon rotation of the roller blind in said other one of the winding and unwinding directions. In some embodiments, said at least one friction-creating surface is at least one of radially and axially spaced apart from the first portion of the tube-coupling bearing. In some embodiments, considered in a plane transversal to the shaft axis, the first portion of the tube-coupling bearing at least partially surrounds the second portion thereof. In some embodiments, the first portion further comprises flexible tube-engaging tongues protruding outwardly from an outer surface thereof that are dimensioned and shaped so that the tube-coupling bearing substantially conforms to the inner surface of the roller blind tube when in use.

According to another general aspect, there is provided a roller blind system comprising: a roller blind tube having a tube longitudinal axis and defining a mechanism-receiving cavity; and a roller blind friction-creating assembly according to the present disclosure at least partially arranged in the mechanism-receiving cavity, wherein the first portion of the tube-coupling bearing is angularly coupled with an inner surface of the roller blind tube at least partially delimiting the mechanism-receiving cavity.

According to another general aspect, there is provided a roller blind friction-creating assembly for a roller blind system comprising a roller blind tube rotatable about a tube longitudinal axis into opposed winding and unwinding directions, the friction-creating assembly comprising: a support-mounting shaft system mountable to a roller blind support, the support-mounting shaft system having a shaft axis; a tube-coupling bearing having an outer portion angularly couplable with the roller blind tube and an inner portion rotatably mounted onto the support-mounting shaft system in at least one rotating direction about the shaft axis when in use, upon rotation of the roller blind tube about the tube longitudinal axis in the winding and unwinding directions; and a friction-creating system angularly coupled with the support-mounting shaft system and contacting at least partially the tube-coupling bearing; wherein the friction-creating system provides a friction couple to the tube-coupling bearing upon rotation thereof about the shaft axis in said at least one rotating direction.

According to another general aspect, there is provided a roller blind system comprising: a roller blind tube having a tube longitudinal axis and defining a mechanism-receiving cavity; and a roller blind friction-creating assembly according to the present disclosure at least partially arranged in the mechanism-receiving cavity, wherein the outer portion of the tube-coupling bearing is angularly coupled with the roller blind tube.

According to another general aspect, there is provided a one-way bearing having a central axis, comprising: an inner race comprising an outer surface; an outer race surrounding at least partially the inner race and comprising an inner surface, at least a portion of the inner surface being radially spaced apart from the outer surface of the inner race to define at least one coupling member-receiving chamber between the inner and outer races; and at least one unidirectional coupling member provided in said at least one coupling member-receiving chamber; wherein the outer surface of the inner race at least partially forms first and second tangential wall portions at least partially delimiting said at least one coupling member-receiving chamber; wherein said at least one unidirectional coupling member is engageable with the inner surface of the outer race when the outer race is rotated about the central axis in a first direction, thus rotating the inner race in the first direction upon abutment of said at least one unidirectional coupling member against one of the first and second tangential wall portions; and wherein said at least one unidirectional coupling member is free from sliding along the inner surface of the outer race when the outer race rotates about the central axis in a second direction opposed to the first direction, thus allowing a free rotation of the outer race with respect to the inner race, said at least one coupling member having an outer surface at least partially mateable with the inner surface of the outer race.

### BRIEF DESCRIPTION OF THE DRAWINGS

FIG. 1 is a first perspective view of a roller blind friction-creating assembly in accordance with a first embodiment, the friction-creating assembly comprising a bidirectional tube-coupling bearing and a support-mounting shaft system comprising a shaft member;

FIG. 2 is a second perspective view, exploded, of the roller blind friction-creating assembly of FIG. 1, the shaft member being removed;

FIG. 3 is a perspective view of the roller blind friction-creating assembly of FIG. 2, the friction-creating assembly comprising a friction adjuster configured in a first longitudinal configuration;

FIG. 4 is a perspective view of the roller blind friction-creating assembly of FIG. 2, the friction adjuster being configured in a second longitudinal configuration different from the first longitudinal configuration of FIG. 3;

FIG. 5 is a perspective view, exploded, of a roller blind friction-creating assembly in accordance with a second embodiment, the friction-creating assembly comprising a one-way tube-coupling bearing;

FIG. 6 is a first perspective view, exploded, of the one-way tube-coupling bearing of FIG. 5;

FIG. 7 is a second perspective view, exploded, of the one-way tube-coupling bearing of FIG. 5;

FIG. 8 is a cross-section view of the one-way tube-coupling bearing of FIG. 5, an outer race and an inner race thereof being rotated together in a first direction;

FIG. 8A is an enlarged partial view of the one-way tube-coupling bearing of FIG. 8;

FIG. 9 is a cross-section view of the one-way tube-coupling bearing of FIG. 5, the outer race thereof being freely rotated in a second direction with respect to the inner race thereof, the second direction being opposed to the first direction of FIG. 8;

FIG. 10 is a perspective view, partially exploded, of a roller blind system comprising a roller blind tube and a roller blind mechanism comprising the roller blind friction-creating assembly of FIG. 1;

FIG. 11 is an enlarged perspective view of the roller blind mechanism of FIG. 10;

FIG. 12 is a longitudinal cross-sectional view of the roller blind mechanism of FIG. 10;

FIG. 13 is another possible embodiment of a roller blind mechanism comprising the roller blind friction-creating assembly of FIG. 1; and

FIG. 14 is a longitudinal cross-sectional view of the roller blind mechanism of FIG. 13.

### DETAILED DESCRIPTION

In the following description, the same numerical references refer to similar elements. Furthermore, for the sake of simplicity and clarity, namely so as to not unduly burden the figures with several references numbers, not all figures contain references to all the components and features, and references to some components and features may be found in only one figure, and components and features of the present disclosure which are illustrated in other figures can be easily inferred therefrom. The embodiments, geometrical configurations, materials mentioned and/or dimensions shown in the figures are optional and are given for exemplification purposes only. Moreover, it will be appreciated that positional descriptions such as “above”, “below”, “forward”, “rearward”, “left”, “right” and the like should, unless otherwise indicated, be taken in the context of the figures only and should not be considered limiting. Moreover, the figures are meant to be illustrative of certain characteristics of the one-way bearing, the roller blind friction-creating assembly and the roller blind system comprising the same and are not necessarily to scale.

To provide a more concise description, some of the quantitative expressions given herein may be qualified with the term “about”. It is understood that whether the term “about” is used explicitly or not, every quantity given herein is meant to refer to an actual given value, and it is also meant to refer to the approximation to such given value that would reasonably be inferred based on the ordinary skill in the art, including approximations due to the experimental and/or measurement conditions for such given value. In the following description, an embodiment is an example or implementation. The various appearances of “one embodiment”, “an embodiment” or “some embodiments” do not necessarily all refer to the same embodiments. Although various features may be described in the context of a single embodiment, the features may also be provided separately or in any suitable combination. Conversely, although the invention may be described herein in the context of separate embodiments for clarity, it may also be implemented in a single embodiment. Reference in the specification to “some embodiments”, “an embodiment”, “one embodiment” or “other embodiments” means that a particular feature, structure, or characteristic described in connection with the embodiments is included in at least some embodiments, but not necessarily all embodiments.

It is to be understood that the phraseology and terminology employed herein is not to be construed as limiting and are for descriptive purpose only. The principles and uses of the teachings of the present disclosure may be better understood with reference to the accompanying description, figures and examples. It is to be understood that the details set forth herein do not construe a limitation to an application of the disclosure. Furthermore, it is to be understood that the disclosure can be carried out or practiced in various ways and that the disclosure can be implemented in embodiments other than the ones outlined in the description above. It is to be understood that the terms “including”, “comprising”, and grammatical variants thereof do not preclude the addition of one or more components, features, steps, or integers or groups thereof and that the terms are to be construed as specifying components, features, steps or integers. If the specification or claims refer to “an additional” element, that does not preclude there being more than one of the additional element. It is to be understood that where the claims or specification refer to “a” or “an” element, such reference is not to be construed that there is only one of that element. It is to be understood that where the specification states that a component, feature, structure, or characteristic “may”, “might”, “can” or “could” be included, that particular component, feature, structure, or characteristic is not required to be included.

The descriptions, examples, methods and materials presented in the claims and the specification are not to be construed as limiting but rather as illustrative only. Meanings of technical and scientific terms used herein are to be commonly understood as by one of ordinary skill in the art to which the invention belongs, unless otherwise defined. It will be appreciated that the methods described herein may be performed in the described order, or in any suitable order.

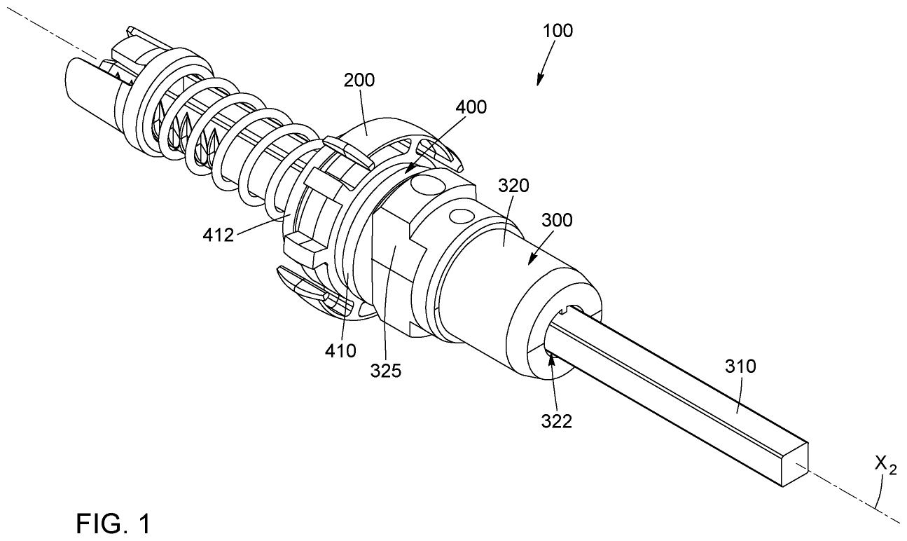

Referring now to the drawings, and more particularly to FIGS. 1 to 4 and 10, there is shown a roller blind system 10 comprising a roller blind tube assembly 50 and a roller blind mechanism 30 (or roller bling tube-supporting assembly 30). The roller blind tube assembly 50 comprises a roller blind tube 52 defining a mechanism-receiving cavity 54 and having a tube longitudinal axis X1. Moreover, a blind 56 (or window covering 56, or shade 56), for instance at least partially made of fabric and/or of one or more layers of a flexible element, is mounted to (for instance secured to an outer surface thereof) the roller blind tube 52 and is at least partially wrapped around the roller blind tube 52. The present disclosure is obviously not limited to a blind that would be formed of fabrics but could also comprise a venetian blind or any other element extendable and retractable in a substantially vertical plane. The blind 56 comprises, in the embodiment shown, a weight bar 58 secured to a bottom edge of the blind 56 (or fabric 56) to maintain the blind in a substantially vertical configuration when the blind 56 is at least partially in an unwound configuration (or extended configuration), for instance for the blind to at least partially cover a window or an opening.

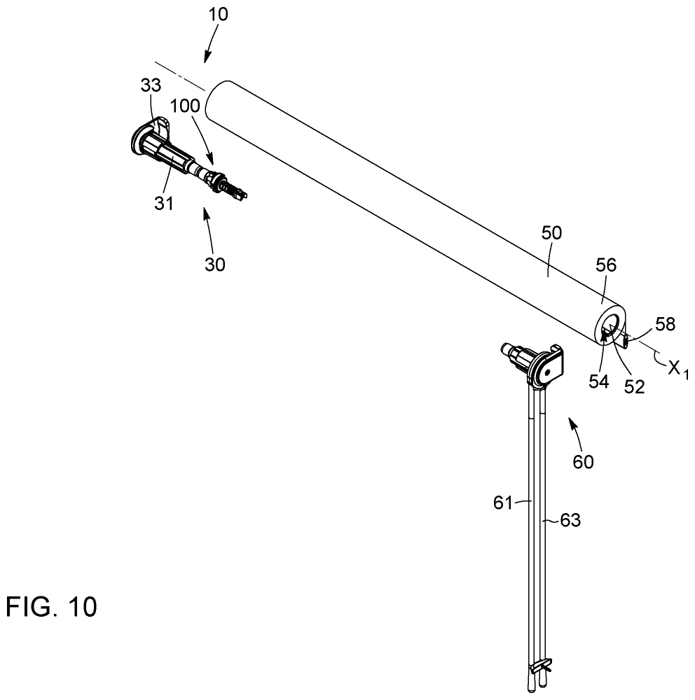

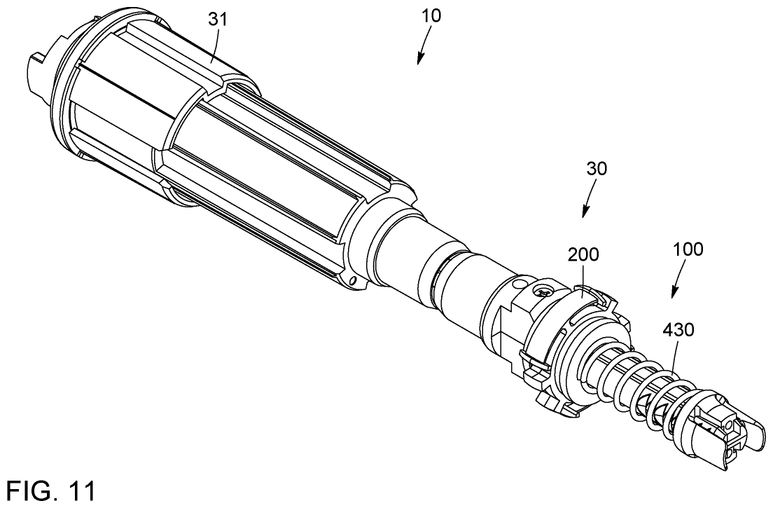

The roller blind system 10 further comprises an actuator 60 (FIG. 10) configured to cooperate with the roller blind tube 52 to extend and retract the blind 56. In other words, the actuator 60 cooperates with the roller blind tube 52 to configure the blind 56 either in the unwound configuration (or extended configuration) wherein the bottom edge (for instance the weight bar 58) is in a lower end position, in a wound configuration (or retracted configuration), in which the blind 56 is at least partially wrapped around the roller blind tube 52, wherein the bottom edge is in an upper end position vertically above the lower end position, or in any configuration wherein the bottom edge (for instance the weight bar 58) is between the lower end position and the upper end position. In the embodiment shown, the actuator 60 comprises first and second actuation rods 61, 63, but the present disclosure is not limited to a roller blind mechanism for a roller blind system comprising first and second actuation rods; the roller blind mechanism of the present disclosure could be used with any other type of actuators, such as for instance and without being limitative a cord. The roller blind mechanism could also be used with a roller blind system of the free-lift style (i.e., actuated directly by a user pulling or pushing the bottom edge or any other part of the blind 56). It is thus understood that the roller blind tube 52 is rotatable about the tube longitudinal axis X1 into opposed winding and unwinding directions, for instance upon actuation of the actuator 60 (upon actuation of at least one of the first and second actuation rods 61, 63 thereof in the embodiment shown).

The roller blind mechanism 30 comprises a roller blind tube-supporting system 31 (FIG. 10) configured to support a portion of the roller blind tube 52 (for instance an end portion of the roller blind tube 52 opposed to an end portion cooperating with the roller blind actuator 60). In other words, the roller blind system 10 forms a window covering system comprising a blind or window covering or shade retractable and extendable for a bottom edge thereof to be displaceable along a substantially vertical direction between the upper and lower end positions. In the embodiment shown, the roller blind system 10 further comprises a support-mounting extremity 33 fixedly mountable to a holding element or holding surface or roller blind support (for instance a building structure), for instance via a roller blind-supporting bracket and an opposed free extremity, extending in the mechanism-receiving cavity 54 when the roller blind mechanism 30 is inserted therein. In the embodiment shown, the roller blind tube-supporting system 31 is engageable (for instance in a removable manner) with the support-mounting extremity 33.

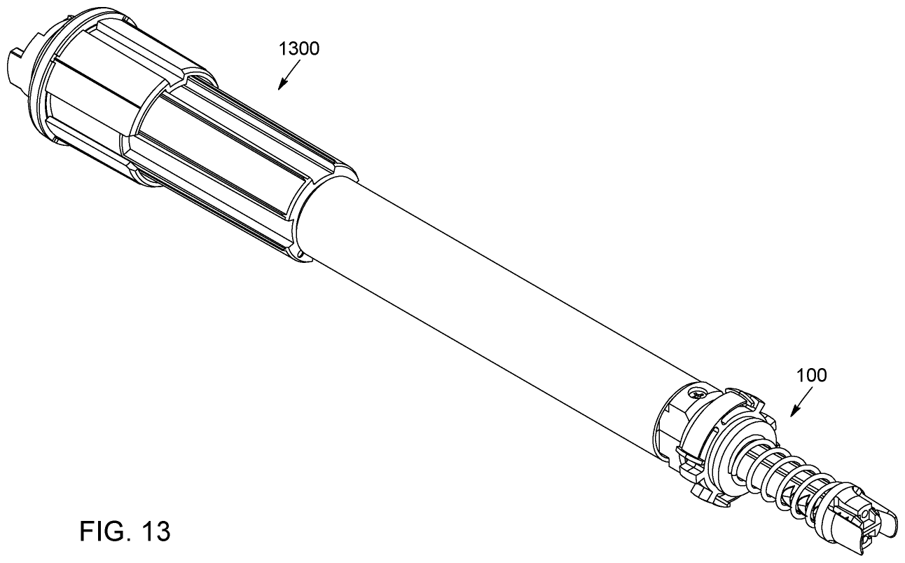

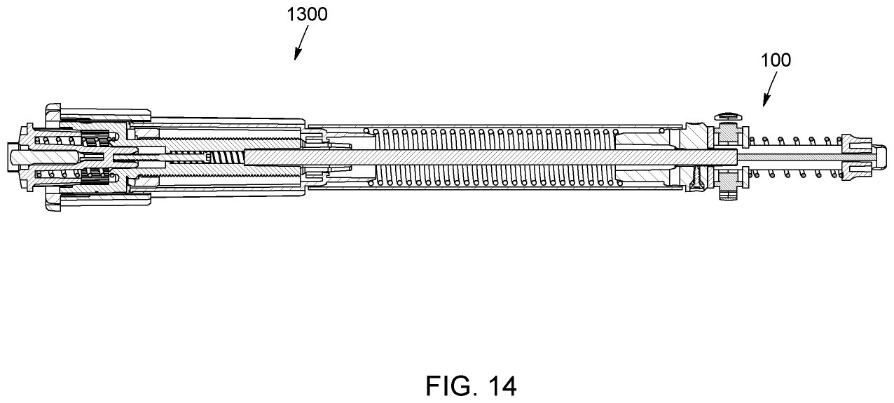

In the embodiment shown, the roller blind system 10 (for instance the roller blind mechanism 30 thereof) further comprises a roller blind friction-creating assembly 100 in accordance with a first embodiment at least partially arranged in the mechanism-receiving cavity 54. As detailed below, the roller blind friction-creating assembly 100 comprises a tube-coupling bearing 200 having an outer portion angularly coupled with the roller blind tube 52 (angularly coupled with an inner surface thereof, in the embodiment shown) and an inner portion. In the following description, unless otherwise stated, the terms inner and outer should be understood with respect to the tube longitudinal axis. The present disclosure is not limited to a roller blind friction-creating assembly 100 that would form part of a roller blind mechanism 30 as represented in FIGS. 10 to 12. As represented in FIGS. 13 and 14, the roller blind friction-creating assembly 100 according to any one of the embodiments of the present disclosure could form part of a spring-biased roller blind mechanism 1300. A possible embodiment of the roller blind mechanism is described for instance in WO 2020/132750 by the applicant, the disclosure of which being hereby incorporated by reference in its entirety.

Referring now more particularly to FIGS. 1 to 4, the roller blind mechanism 100 in accordance with the first embodiment is represented.

### Roller Blind Friction-Creating Assembly

In the embodiment shown, the roller blind friction-creating assembly 100 (or friction-creating assembly 100) comprises a support-mounting shaft system 300 mountable to a roller blind support, the support-mounting shaft system 300 having a shaft axis X2. In the embodiment shown, when the roller blind friction-creating assembly 100 is arranged in the mechanism-receiving cavity 54 of the roller blind tube 52, the tube longitudinal axis X1 and the shaft axis X2 are substantially parallel, for instance substantially coincident.

The friction-creation assembly 100 further comprises the above-mentioned tube-coupling bearing 200 with the outer portion angularly couplable with the roller blind tube 52 (for instance with the inner surface thereof) and with the inner portion rotatably mounted onto the support-mounting shaft system 300 in at least one rotating direction about the shaft axis X2 when in use, upon rotation of the roller blind tube 52 about the tube longitudinal axis X1 in the winding and unwinding directions. In other words, the rotation of the roller blind tube 52 about the tube longitudinal axis X1 in at least one of the winding and unwinding directions rotate the inner and outer portions of the tube-coupling bearing 200 together about the shaft axis X2, while the support-mounting shaft 300 is prevented from rotating.

The friction-creating assembly 100 also comprises a friction-creating system 400 angularly coupled with the support-mounting shaft system 300 and contacting at least partially the tube-coupling bearing 200 (i.e., having at least a portion contacting the tube-coupling bearing 200), wherein the friction-creating system 400 provides a friction couple to the tube-coupling bearing 200 upon rotation thereof about the shaft axis X2 in the at least one rotating direction. It is thus understood that when the roller blind tube 52 is rotated about the tube longitudinal axis X1 in at least one of the winding and unwinding directions with the inner and outer portions of the tube-coupling bearing 200 being rotated together about the shaft axis X2, the friction-creating system 400 (at least a bearing-contacting surface thereof) remains stationary (i.e., is prevented from rotating about the shaft axis X2), thus providing a friction couple to the tube-coupling bearing 200.

The different components of the roller blind friction-creating assembly 100 will now be described in more details.

### Support-Mounting Shaft System

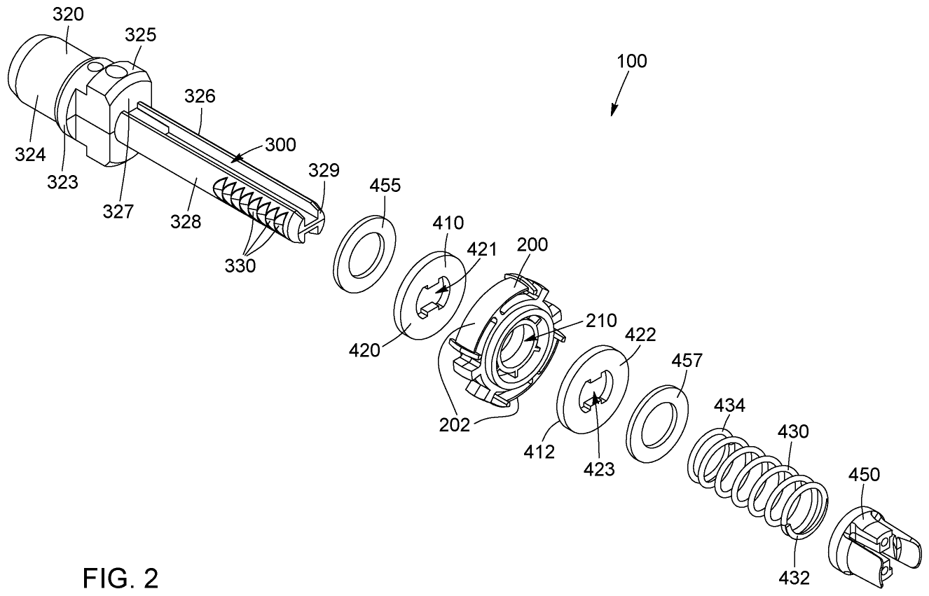

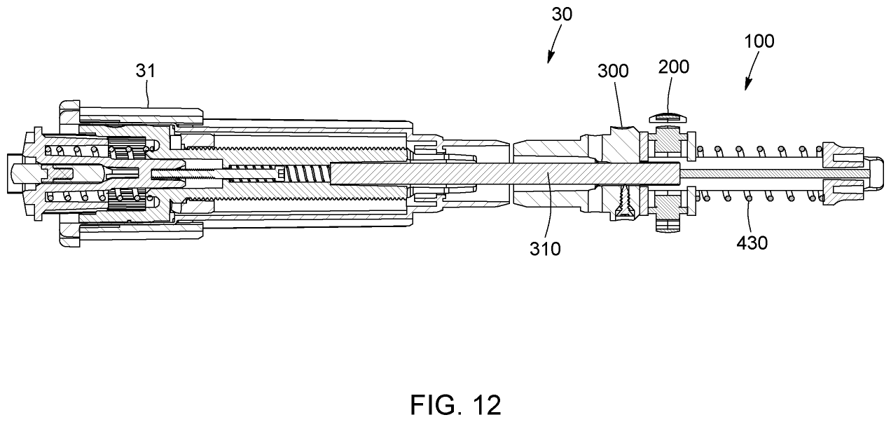

In the embodiment shown, as represented for instance in FIGS. 1 and 2, the support-mounting shaft system 300 comprises a shaft member 310 (for instance having a substantially square cross section) and a bearing-supporting member 320 at least partially engaged with the square shaft member 310. The shaft member 310 extends along the shaft axis X2 and is engageable (for instance removably, for instance via a first longitudinal end portion thereof) with the bearing-supporting member 320 (with a shaft-receiving opening 322 formed therein, in the embodiment shown) and (for instance via an opposed second longitudinal end portion thereof) with the roller blind tube-supporting system 31 (FIG. 12).

The bearing-supporting member 320 extends along the shaft axis X2. The shaft-receiving cavity 322 formed therein is shaped and dimensioned to at least partially receive the shaft member 310. The support-mounting shaft system 300 is mountable either directly or indirectly to the roller blind support (for instance via the shaft member 310 being engaged with the support-mounting extremity 33) in order to prevent the support-mounting shaft system 300 from rotating about the shaft axis X2 upon rotation of the roller blind tube 52 about the tube longitudinal axis X1 in the winding and unwinding directions.

In the embodiment shown, the bearing-supporting member 320 has a shaft-engaging end portion 323 (for instance substantially cylindrical) in which the shaft-receiving cavity 322 is formed. The bearing-supporting member 320 further comprises a bearing-supporting end portion 326 extending along the shaft axis X2. As best shown in FIG. 2, the bearing-supporting end portion 326 has a non-circular cross section (for instance and without being limitative, a substantially H-shaped cross section). In the embodiment shown, an outer surface 328 of the bearing-supporting end portion 326 has a plurality of biasing member-engaging portions 330 formed thereon. In the embodiment shown, the biasing member-engaging portions 330 comprise notches formed on the outer surface 328 of the bearing-supporting end portion 326 that are axially spaced apart from each other, considered along the shaft axis X2.

As detailed below, the support-mounting shaft system 300 (the bearing-supporting end portion 326 of the bearing-supporting member 320 thereof, in the embodiment shown) is shaped and dimensioned to rotatably support the tube-coupling bearing 200 (the inner portion thereof) while being angularly coupled with the friction-creating system 400.

It is appreciated that the shape, the configuration and the location of the support-mounting shaft system 300, as well as the shape, the configuration and the relative arrangement of the shaft member 310 and the bearing-supporting member 320 thereof can vary from the embodiment shown.

### Tube-Coupling Bearing

In the first embodiment shown, the tube-coupling bearing 200 is single-pieced and is shaped and dimensioned to be rotated about the shaft axis X2 into two opposed rotating directions when in use, upon rotation of the roller blind tube 52 respectively in the winding and unwinding directions. In other words, in the first embodiment shown, the tube-coupling bearing 200 is a two-way (or two-direction or bidirectional) bearing. It is thus understood that in the first embodiment, the inner and outer portions of the tube-coupling bearing 200 are angularly coupled with each other (are formed integral with each other, in the first embodiment shown) upon rotation of the roller blind tube 52 in the winding and unwinding directions. The present disclosure is not limited to a single-pieced two-way tube-coupling bearing.

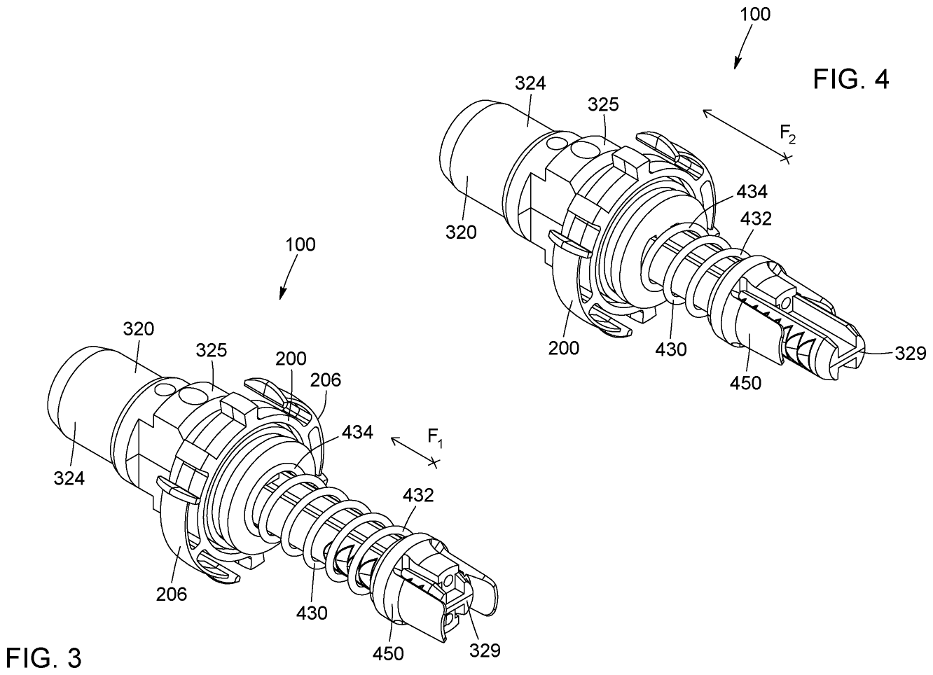

In the embodiment shown, the tube-coupling bearing 200 has an outer surface with angular couplers 202 formed thereon, that are configured to cooperate with corresponding angular couplers formed on the inner surface of the roller blind tube 52 so that when the roller blind friction-creating assembly 100 (at least the tube-coupling bearing 200 thereof) is inserted into the mechanism-receiving cavity 54 of the roller blind tube 52, the tube-coupling bearing 200 and the roller blind tube 52 are angularly coupled to each other upon rotation of the roller blind tube 52 about the tube longitudinal axis X1 (for instance upon actuation of the actuator 60) in the winding and unwinding directions. The tube-coupling bearing 200 further comprises flexible tongues 206 (two, in the embodiment shown-FIG. 3) protruding outwardly from the outer surface thereof that are dimensioned and shaped so that the tube-coupling bearing 200 substantially conforms to the inner surface of the roller blind tube 52. The flexible tongues 206 thus contribute to the angular coupling of the tube-coupling bearing 200 and the roller blind tube 52 and limit the risk of the tube-coupling bearing 200 being either too tight or too loose with respect to dimensions of the roller blind tube 52 (for instance dimensions of the mechanism-receiving cavity 54 thereof), that would not be satisfactory and/or that might cause undesirable noises. It is understood that the number, shape and dimensions of the flexible tongues 206 are not limited to the embodiment shown. Moreover, the tube-coupling bearing 200 has an inner cavity 210 formed therein, extending along the shaft axis X2 when mounted onto the support-mounting shaft system 300 (onto the bearing-supporting end portion 326 thereof, in the embodiment shown) and shaped and dimensioned to be rotatably mounted onto the bearing-supporting end portion 326 of the bearing-supporting member 320. In the embodiment shown, the inner cavity 210 is substantially cylindrical.

It is appreciated that the shape, the configuration, and the location of the tube-coupling bearing relative to the support-mounting shaft portion can vary from the embodiment shown.

### Friction-Creating System

In the embodiment shown, the friction-creating system 400 comprises at least one bearing-contacting surface 410, 412 (two, in the embodiment shown) which is shaped and dimensioned to contact at least a portion of the tube-coupling bearing 200 (lateral sides thereof or longitudinal end portions thereof, in the embodiment shown). In the embodiment shown, the friction-creating system comprises first and second friction-creating disks 420, 422 (or first and second friction-creating washers, or first and second friction-creating pads 420, 422) forming at least partially respectively the first and second bearing-contacting surfaces 410, 412. The first and second friction-creating pads 420, 422 are angularly coupled with the support-mounting shaft system 300 (for instance with the bearing-supporting member 320 thereof, for instance with the bearing-supporting end portion 326 thereof). In the embodiment shown, the first and second friction-creating disks 420, 422 each comprise a central opening 421, 423 (or shaft-engaging opening) having a cross section corresponding substantially to the outer cross section of the bearing-supporting end portion 326. When engaged with the bearing-supporting member 320, the first and second friction-creating disks 420, 422 are thus angularly coupled therewith. For instance, the first and second friction-creating disks 420, 422 are at least partially formed in a friction-creating material (for instance a rubber material and the like).

In the embodiment shown, when mounted onto the bearing-supporting end portion 326 of the bearing-supporting member 320, the first and second friction-creating disks 420, 422 are axially arranged on each side of the tube-coupling bearing 200 (i.e., the tube-coupling bearing 200 is at least partially sandwiched between the first and second friction-creating disks 420, 422). It is thus understood that the bearing-contacting surfaces 410, 412 of the friction-creating system 400 are formed by surfaces of the first and second friction-creating disks 420, 422 facing the tube-coupling bearing 200 (i.e., by bearing-facing surfaces of the first and second friction-creating disks).

In the embodiment shown, the friction-creating system 400 further comprises a biasing member 430 arranged to bias at least one of the bearing-contacting surfaces 410, 412 (both of them, in the embodiment shown) towards the tube-coupling bearing 200. In other words, the biasing member 430 is shaped and dimensioned to increase a contact between the tube-coupling bearing 200 and at least one of the first and second friction-creating disks 420, 422 (and at least one of the first and second bearing-contacting surfaces thereof).

In the embodiment shown, considered along the shaft axis X2, the first friction-creating disk 420 is arranged between a disk-abutting portion 325 of the bearing-supporting member 320 and the tube-coupling bearing 200. In the embodiment shown, the disk-abutting portion 325 has a disk-contacting surface 327 extending substantially perpendicular to the shaft axis X2 and has dimensions equal to or greater than dimensions of the first friction-creating disk 420, thus ensuring a close and stable contact (either direct or indirect) between the bearing-supporting member 320 (the disk-abutting portion 325 thereof, in the embodiment shown) and the first friction-creating disk 420. Considered along the shaft axis X2 and as mentioned above, the tube-coupling bearing 200 is arranged between the first and second friction-creating disks 420, 422. The biasing member 430 is arranged (directly or indirectly) between the second friction-creating disk 422 and a distal end portion 329 of the bearing-supporting end portion 326 (considered with respect with the disk-abutting portion 325 of the bearing-supporting member 320). In the embodiment shown, the friction-creating assembly 400 further comprises first and second pressure-applying disks 455, 457 (or pressure-applying washers 455, 457 or pressure-applying rings 455, 457) for instance at least partially formed in a substantially rigid material, such as steel. In the embodiment shown, considered along the shaft axis X2, the first pressure-applying disk 455 is arranged between the disk-abutting portion 325 of the bearing-supporting member 320, and the first friction-creating disk 420. Considered along the shaft axis X2, the second pressure-applying disk 457 is arranged between the biasing member 430 and the second friction-creating disk 422. In the embodiment shown, the first and second pressure-applying disks (or pressure-applying rings) have a central through opening (or shaft-engaging opening), for the washers 455, 457 to be mounted onto the bearing-supporting member 320 (onto the bearing-supporting end portion 326 thereof, in the embodiment shown). The first and second pressure-applying disks 455, 457 or washers are shaped and dimensioned to spread or apply a pressure substantially evenly onto the corresponding one of the first and second friction-creating disks 420, 422 and/or to limit the risk that the corresponding one of the first and second friction-creating disks 420, 422 be deformed upon the system being used overtime, for instance due to creeping. It is appreciated that the shape, the configuration, the material and/or the location of the first and second pressure-applying disks can vary from the embodiment shown. It could also be conceived a roller blind friction-creating system with no or only one pressure-applying disk. For the sake of simplicity and clarity, namely so as to not unduly burden the figures, the first and second pressure-applying washers 455, 457 are only represented on FIG. 2.

In the embodiment shown, the biasing member 430 is a compression spring mounted onto the bearing-supporting member 320 (onto the bearing-supporting end portion 326 thereof in the embodiment shown, i.e., at least partially surrounding the bearing-supporting end portion 326) and extending along the shaft axis X2. The biasing member 430 comprises first and second longitudinal end portions 432, 434 (or distal and proximal longitudinal end portions 432, 434, considered with respect with the disk-abutting portion 325 of the bearing-supporting member 320). In the embodiment shown, the proximal end portion 434 of the biasing member 430 abuts the second friction-creating disk 422 to bias the second friction-creating disk 422 against (or towards) the tube-coupling bearing 200. The biasing member 430 also bias the tube-coupling bearing 200 towards the first friction-creating disk 420 and bias the first friction-creating disk 420 towards the disk-abutting portion 325. The distal longitudinal end portion 432 of the biasing member 430 is engaged with the support-mounting shaft system 300 (with the outer surface 328 of the bearing-supporting member 320, in the embodiment shown).

In the embodiment shown, the friction-creating system 400 further comprises a friction adjuster 450 configured to engage the distal longitudinal end portion 432 of the biasing member 430 (i.e., to couple the distal longitudinal end portion 432 of the biasing member with the bearing-supporting member 320 at a particular longitudinal position thereof). Considered along the shaft axis X2, the biasing member 430 is arranged (or sandwiched, or constrained) between the second friction-creating disk 422 and the friction adjuster 450. The friction adjuster 450 is configured to adjust a value of a biasing force applied by the biasing member 430 onto at least one bearing-contacting surface 410, 412 (onto the first and second friction-creating disks 420, 422 in the embodiment shown). As best shown in FIGS. 2 to 4, the friction adjuster 450 is configurable into a plurality of longitudinal positions onto the bearing-supporting member 320 in order to apply biasing forces having different values onto the bearing-contacting surfaces 410, 412 (i.e., in order to provide the tube-coupling bearing 200 with friction couples of different intensities). In the embodiment shown, the friction adjuster 450 is mountable to (i.e., engageable with) the bearing-supporting member 320 at different longitudinal positions defined by the above-mentioned plurality of biasing member-engaging portions 330 formed onto the outer surface 328 of the bearing-supporting end portion 326. It is thus understood that the roller blind friction-creating assembly 100 can be easily adapted to different types of roller blind systems it is configured to equip (for instance depending on the dimensions and/or the weight of the roller blind tube and/or the blind).

For instance, FIGS. 3 and 4 represent respectively first and second configurations of the friction-creating system 400: in the first configuration, the friction adjuster 450 is mounted onto the bearing-supporting member 320 closer to the distal end portion 329 of the bearing-supporting end portion 326 than in the second configuration. It is thus understood that a value of the biasing force F1 applied by the biasing member 430 onto the second friction-creating disk 422 in the first configuration is smaller than a value of the biasing force F2 applied by the biasing member 430 onto the second friction-creating disk 422 in the second configuration.

It is appreciated that the shape and the configuration of the friction-creating system, as well as the shape, the configuration, the material, the number and/or the relative arrangement of the first and second friction-creating disks, the biasing member and/or the friction adjuster thereof can vary from the embodiment shown.

### Method for Creating a Friction Upon Rotation of a Roller Blind Tube

It is thus understood that the roller blind friction-creating assembly 100 is configured to provide a friction upon rotation of the roller blind tube 52 about the tube longitudinal axis X1 in at least one of the winding and unwinding directions (both the winding and unwinding directions, in the first embodiment shown).

By contacting at least partially the tube-coupling bearing 200 (by contacting opposed sides thereof or opposed longitudinal end portions thereof, in the embodiment shown), the friction-creating system 400 provides a friction couple to the tube-coupling bearing 200 upon rotation thereof about the shaft axis X2 in at least one rotating direction (in both opposed rotating directions about the shaft axis X2, in the first embodiment of the friction-creating assembly 100). Moreover, varying a value of the biasing force applied by the biasing member 430 onto at least one bearing-contacting surface 410, 412 (for instance by modifying a longitudinal position of the friction adjuster 450 in the embodiment shown) allows varying a value of the friction couple provided to the tube-coupling bearing 200.

The friction couple is provided by the friction-creating system 400 when the roller blind tube, and thus the tube-coupling bearing 200 angularly coupled therewith, are pivoted in at least one of the winding and unwinding directions about the tube longitudinal axis X1. As detailed above, the first and second friction-creating disks 420, 422 are slidably mounted onto the bearing-supporting end portion 326 of the bearing-supporting member 320 while being prevented from rotating about the shaft axis X2 (thanks to the outer cross section of the outer surface 328 of the bearing-supporting end portion 326 and the inner cross section of the shaft-engaging openings 421, 423 of the disks 420, 422, in the embodiment shown) upon rotation of the roller blind tube 52 in any direction about the tube longitudinal axis X1. The bearing-supporting member 320 of the support-mounting shaft system 300 and the friction-creating system 400 (thanks to the plurality of biasing member-engaging portions 330 formed onto the outer surface 328 of the bearing-supporting end portion 326 and the friction adjuster 450) allows adjusting an intensity of the friction couple provided to the tube-coupling bearing 200.

### 2^{nd} Possible Embodiment

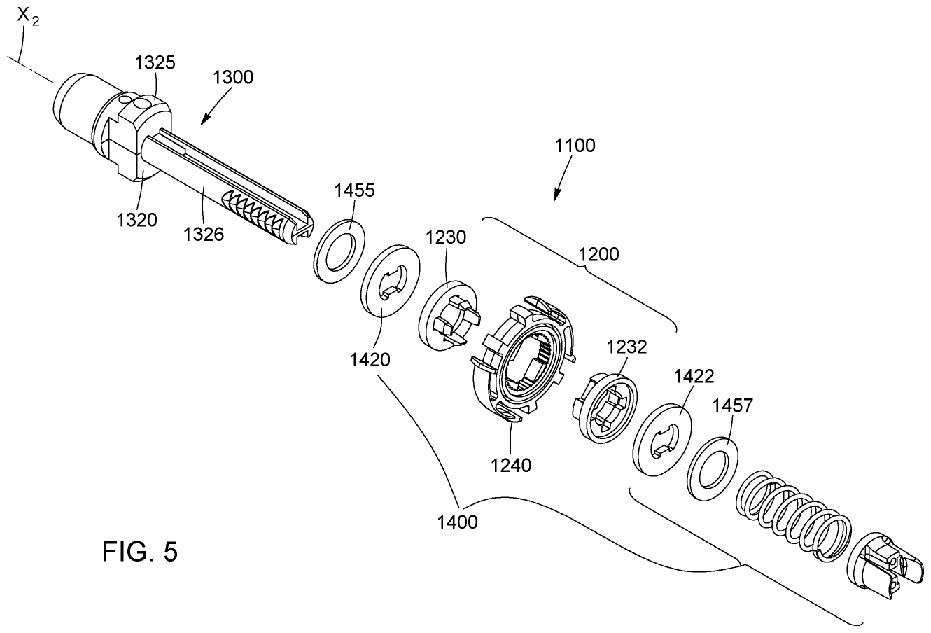

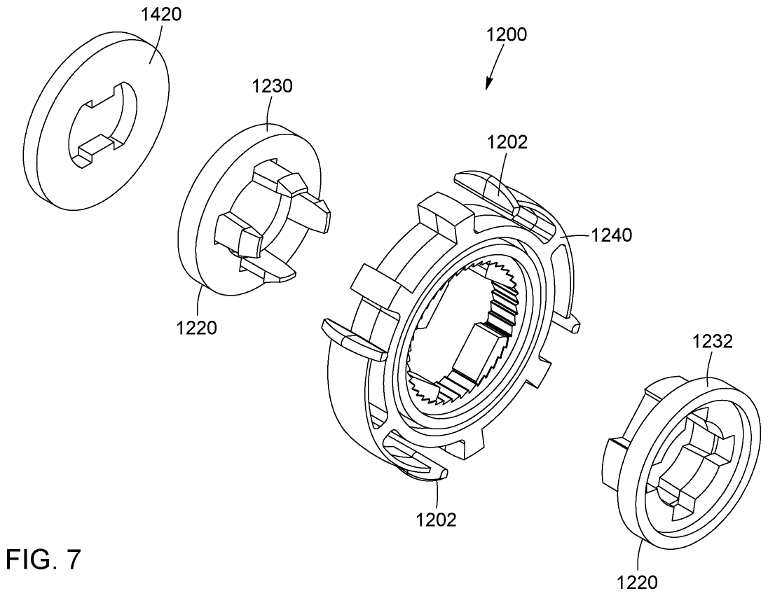

Referring now to FIGS. 5 to 9, there is shown a second possible embodiment of a roller blind friction-creating assembly 1100 (or friction-creating assembly 1100).

Similarly to the first embodiment, the roller blind friction-creating assembly 1100 in accordance with the second embodiment is for a roller blind system comprising a roller blind tube 52 rotatable about a tube longitudinal axis X1 into opposed winding and unwinding directions. The friction-creating assembly 1100 comprises a support-mounting shaft system 1300 mountable to a roller blind support, the support-mounting shaft system 1300 having a shaft axis X2; a tube-coupling bearing 1200 having an outer portion (or outer race) angularly couplable with the roller blind tube 52 (with an inner surface thereof, for instance) and an inner portion (or inner race) rotatably mounted onto the support-mounting shaft system 1300 in a single rotating direction about the shaft axis X2 when in use, upon rotation of the roller blind tube 52 about the tube longitudinal axis X1 in the winding and unwinding directions. The friction-creating assembly 1100 further comprises a friction-creating system 1400 (comprising first and second friction-creating disks 1420, 1422 in the embodiment shown as well as first and second pressure-applying rings or washers 1455, 1457) angularly coupled with the support-mounting shaft system 1300 and contacting at least partially the tube-coupling bearing 1200 (at least partially the inner race thereof, in the embodiment shown). As detailed above with respect with the first embodiment, the friction-creating system 1400 provides a friction couple to the tube-coupling bearing 1200 (to the inner race thereof, in the embodiment shown) upon rotation thereof about the shaft axis X2 in the single rotating direction. For the sake of simplicity and clarity, namely so as to not unduly burden the figures, the first and second pressure-applying washers 1455, 1457 are only represented on FIG. 5.

In the second embodiment shown of the friction-creating assembly 1100, as detailed below, the tube-coupling bearing 1200 is a multi-pieced one-way (or unidirectional) tube-coupling bearing.

### One-Way Bearing

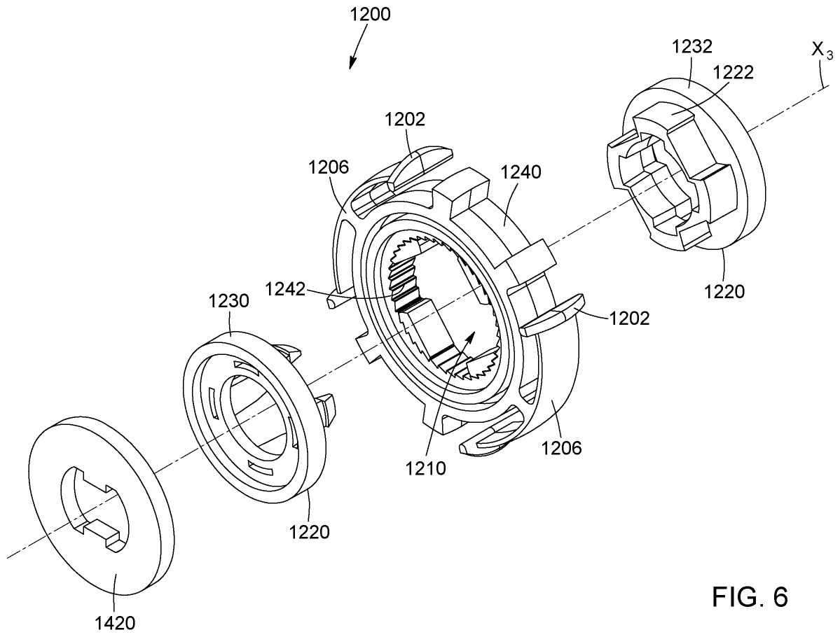

Similarly to the first embodiment, the tube-coupling bearing 1200 has an outer surface (an outer surface of the outer portion or outer race thereof) with angular couplers 1202 (FIG. 6) formed thereon, that are configured to cooperate with corresponding angular couplers formed on the inner surface of the roller blind tube 52 so that when the roller blind friction-creating assembly 1100 (at least the tube-coupling bearing 1200 thereof) is inserted into the mechanism-receiving cavity 54 of the roller blind tube 52, the outer portion of the tube-coupling bearing 1200 and the roller blind tube 52 are angularly coupled to each other upon rotation of the roller blind tube 52 about the tube longitudinal axis X1 in the winding and unwinding directions (for instance upon actuation of the actuator 60). The tube-coupling bearing 1200 (the outer race thereof) further comprises flexible tongues 1206 (two, in the embodiment shown) protruding outwardly from the outer surface thereof that are dimensioned and configured so that the tube-coupling bearing 1200 substantially conforms to the inner surface of the roller blind tube 52. Moreover, the tube-coupling bearing 1200 (the outer race thereof) has an inner cavity 1210 (or inner race-receiving cavity or inner through opening) formed therein, extending along the shaft axis X2 when mounted onto the support-mounting shaft system 1300 (onto the bearing-supporting end portion 1326 (FIG. 5) thereof, in the embodiment shown). In the embodiment shown, the inner cavity 1210 is substantially cylindrical.

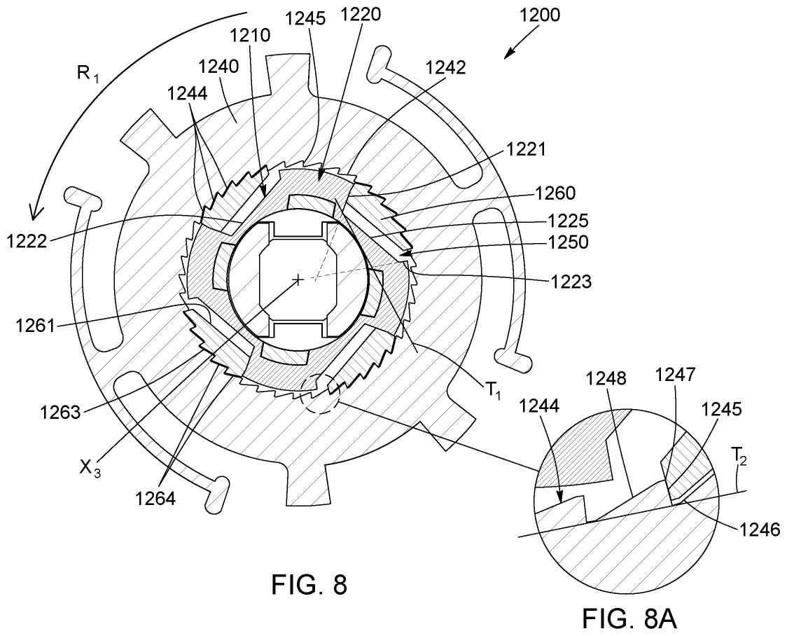

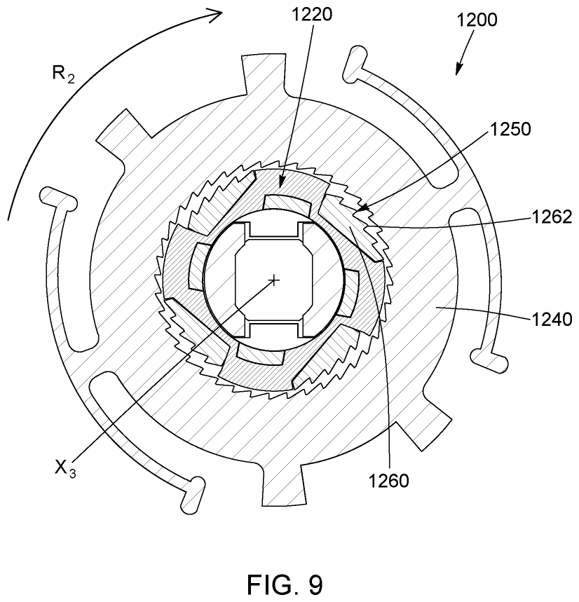

In the embodiment shown, the one-way bearing 1200 has a central axis X3 substantially coincident with the shaft axis X2 when mounted onto the bearing-supporting member 1320 (and with the tube longitudinal axis X1 when the friction-creating assembly 1100 is at least partially arranged in the mechanism-receiving cavity of the roller blind tube 52). In the embodiment shown, the one-way bearing 1200 comprises the inner race 1220 (or inner race assembly 1220, or inner assembly) comprising an outer surface 1222. The outer race 1240 (or outer portion) surrounds (in a radial direction or in a plane substantially transversal to the central axis X3 of the one-way bearing) at least partially the inner race 1220 and comprises an inner surface 1242. At least a portion of the inner surface 1242 of the outer race 1240 is radially spaced apart from the outer surface 1222 of the inner race 1220 to define at least one coupling member-receiving chamber 1250 (FIG. 8) between the inner surface of the outer race and the outer surface of the inner race, considered in a plane transversal to the central axis. In the embodiment shown, the outer surface 1222 of the inner race 1220 at least partially forms first and second tangential wall portions 1221, 1223, or first and second coupler-abutting wall portions 1221, 1223 (FIG. 8) at least partially delimiting the coupling member-receiving chamber 1250 in tangential directions. The one-way bearing 1200 further comprises at least one unidirectional coupling member 1260 provided (or arranged) in the coupling member-receiving chamber 1250. The unidirectional coupling member 1260 is selectively engageable with the inner surface 1242 of the outer race 1240 when the outer race 1240 is rotated about the central axis X3 in a first direction R1 (FIG. 8), thus rotating (or driving into rotation) the inner race 1220 in the first direction about the central axis X3 upon abutment of the unidirectional coupling member 1260 against one of the first and second tangential wall portions 1221, 1223. The unidirectional coupling member 1260 is shaped and dimensioned to slide along the inner surface 1242 of the outer race 1240 when the outer race 1240 rotates about the central axis X3 in a second direction R2 (FIG. 9) opposed to the first direction R1, thus allowing a free rotation of the outer race 1240 with respect to the inner race 1220. As detailed below, the coupling member 1260 has an outer surface 1262 at least partially selectively mateable or engageable with the inner surface 1242 of the outer race 1240.

### Inner Race

In the embodiment shown, the inner race 1220 (or inner race assembly 1220) comprises first and second inner race members 1230, 1232 engaged and angularly coupled with each other to at least partially enclose the unidirectional coupling member therebetween. In the embodiment shown, the first and second inner race members 1230, 1232 (or proximal and distal inner race members 1230, 1232 considered along the central axis X3 and relative to the disk-abutting portion 1325 of the bearing-supporting member 1320) are removably engaged, for instance clipped, to each other to encapsulate therebetween the unidirectional coupling member 1260. Each of the first and second inner race members 1230, 1232 comprises a friction disk-facing side and an opposed coupling side, mechanical couplers (such as flexible tongues or any other suitable mechanical couplers) being provided on the coupling sides of the first and second inner race members 1230, 1232 to engage (for instance in a removable manner) the first and second inner race members 1230, 1232 with each other to form together the inner race.

In the embodiment shown and without being limitative, the first and second inner race members 1230, 1232 are shaped and dimensioned to at least partially delimit four coupling member-receiving chambers 1250 with the outer race 1240 (with the inner surface thereof in the embodiment shown). In the embodiment shown, the coupling member-receiving chambers have a similar shape, so that the following description of one of the coupling member-receiving chambers 1250 will apply to any of them. As best shown in FIGS. 8 and 9 and as mentioned above, the outer surface 1222 of the inner race 1220 (at least partially formed by the distal inner race member 1232 in the embodiment shown) form the first and second tangential wall portions 1221, 1223 at least partially delimiting in opposed tangential directions the coupling member-receiving chamber 1250. One of the first and second tangential wall portions 1221, 1223 forms an outer race-coupling wall portion against which the unidirectional coupling member 1260 abuts when the outer race 1240 is rotated in the first direction R1 about the central axis X3. In the embodiment shown, considered along a radial direction, a height of the first tangential wall portion 1221 is greater than a height of the second tangential wall portion 1223. In the embodiment shown, the outer surface 1222 of the inner race 1220 further forms a bearing-actuating slope 1225 extending between the first and second tangential wall portions 1221, 1223 (between inner end portions thereof, considered in a radial direction, i.e., in a plane transversal to the central axis X3 of the one-way tube-coupling bearing). In the embodiment shown, the bearing-actuating slope 1225 (or bearing-actuating wall portion 1225) inwardly delimit the coupling member-receiving chamber 1250 and is substantially inclined relative to a tangential direction T1 defined between the first and second tangential wall portions 1221, 1223 (for instance the tangential direction T1 is defined at a point equidistant from the inner end portions of the first and second tangential wall portions, as best shown in FIG. 8). In the embodiment shown, as represented for instance in FIGS. 8 and 9, the outer surface 1222 of the inner race 1220 has a substantially cross-shaped outer cross section, thus at least partially delimiting the above-mentioned four coupling member-receiving chambers.

In the embodiment shown, the one-way bearing 1200 is shaped and dimensioned so that the first and second friction-creating disks 1420, 1422 contact respectively the first and second inner race members 1230, 1232 (the friction disk-facing sides thereof), while being axially and radially spaced apart from (i.e., while not contacting) the outer race 1220 of the one-way bearing. In other words, the friction-creating assembly 1100 is shaped and dimensioned so that the outer race 1220 is free from any direct contact with the first and second friction-creating disks 1420, 1420 upon rotation of the outer race in the first and second directions R1, R2.

It is appreciated that the shape and the configuration of the inner race, as well as the shape, the configuration, the relative location and the number of the first and second inner race members and the coupling member-receiving chambers thereof can vary from the embodiment shown.

### Outer Race

In the embodiment, the inner surface 1242 of the outer race 1240 radially delimits the substantially cylindrical inner cavity 1210 of the one-way tube-coupling bearing 1200 and comprises a plurality of indentations (i.e., indentations are formed on the inner surface of the outer race 1240). In the embodiment shown, a serration comprising a plurality of coupling teeth 1244 is formed on the inner surface 1242 of the outer race 1240. The indentations are formed along an entirety of a periphery of the inner surface 1242 and thus delimit an entirety of the cylindrical inner cavity 1210.

In the embodiment shown, each tooth 1244 comprises an abutting portion 1245 extending in a substantially radial direction and defining an inner end 1247 and an outer end 1246, considered with respect to the central axis X3. Each tooth 1244 further comprises a connecting slope 1248 extending between the inner end of the abutting portion of one of the teeth and the outer end of the abutting portion of an adjacent tooth, so that the connecting slope is inclined with respect to a tangential direction T2 defined between the inner ends of the abutting portions of adjacent teeth 1244. In the embodiment shown, the tangential directions T1 and T2 are substantially parallel, considered for a tooth radially aligned with said above-mentioned point equidistant from the inner end portions of the first and second tangential wall portions at least partially delimiting one of the coupling member-receiving chambers.

It is appreciated that the shape and the configuration of the outer race, as well as the shape, the configuration, the relative location and the number of the coupling teeth thereof can vary from the embodiment shown.

### Unidirectional Coupling Member

In the embodiment shown, the one-way bearing 1200 comprises four unidirectional coupling members 1260. Each of the unidirectional coupling members 1260 is provided in a corresponding one of the four coupling member-receiving chambers 1250 and is dimensioned so that the unidirectional coupling member 1260 can be radially spaced apart from the inner surface 1242 of the outer race 1240 (i.e., can be prevented from contacting the inner surface 1242 of the outer race 1240). In the embodiment shown, the unidirectional coupling members 1260 have a similar shape, so that the following description of one of the unidirectional coupling members 1260 will apply to any of them.

In the embodiment shown, as represented for instance in FIGS. 8 and 9, the unidirectional coupling member 1260 has a substantially trapezoidal cross-section (considered in a plane substantially perpendicular to the central axis X3). The unidirectional coupling member 1260 has an inner race-facing side 1261 with a profile corresponding substantially to the bearing-actuating slope 1225 formed by the outer surface of the inner race 1220. The unidirectional coupling member 1260 further comprises an opposed outer race-facing side 1263 forming at least partially the outer surface 1262 selectively mateable or selectively engageable with the inner surface of the outer race. A profile of the outer race-facing side 1263 corresponds thus substantially to the serration (or the plurality of indentations, or the plurality of coupling teeth) formed on the inner surface of the outer race 1240. In other words, a plurality of similar coupling teeth 1264 are formed on the outer surface 1262 of the unidirectional coupling member 1260. The unidirectional coupling member 1260 further comprises first and second tangential sides extending between the inner race-facing side and the outer race-facing side. One of the first and second tangential sides is configured to abut one of the first and second tangential wall portions 1221, 1223 at least partially delimiting the corresponding coupling member-receiving chamber 1250 upon rotation of the outer race 1240 about the central axis X3 in the first direction R1 (FIG. 8). As mentioned above, the unidirectional coupling member 1260 is shaped and dimensioned to be radially and tangentially displaced within the corresponding coupling member-receiving chamber 1250 (for instance via gravity and/or centrifugal force).

It is appreciated that the shape, the configuration and the number of the unidirectional coupling members 1260, as well as the shape, the configuration, the relative location and the number of the coupling teeth thereof can vary from the embodiment shown.

It is thus understood that when the outer race 1240 is rotated in the first direction R1 (FIG. 8—upon rotation of the roller blind tube in one of the winding and unwinding directions, in the embodiment wherein the one way bearing 1220 is configured to equip the roller blind friction-creating assembly 1100), the unidirectional coupling member 1260 is directed radially towards the inner surface of the outer race 1240 (i.e., outwardly displaced) (via gravity and/or centrifugal force), so that the outer surface 1262 (or the outer race-facing side 1263 thereof) contacts the inner surface 1242 of the outer race 1240. Due to the shapes and dimensions of the inner surface of the outer race and the outer surface 1262 of the unidirectional coupling member, the unidirectional coupling member thus engages the inner surface of the outer race and is rotated in the first direction R1 together with the outer race. Upon abutment of the unidirectional coupling member 1260 with one of the tangential wall portions 1221, 1223 at least partially delimiting the corresponding coupling member-receiving chamber 1250, the inner and outer races are then angularly coupled together via the unidirectional coupling member 1260, thus rotating the inner race 1220 about the central axis X3 in the first direction R1 together with the outer race. In the embodiment wherein the one-way bearing 1200 equips the friction-creating assembly 1100, a friction couple is thus provided to the one-way bearing 1200 upon contact of the first and second friction-creating disks with the rotating inner race 1220 (with the rotating first and second inner race members 1230, 1232 thereof, in the embodiment shown).

When the outer race 1240 is rotated in the second direction R2 (FIG. 9—upon rotation of the roller blind tube in the other one of the winding and unwinding directions, in the embodiment wherein the one way bearing 1220 is configured to equip the roller blind friction-creating assembly 1100), due to a geometry of the inner surface of the outer race 1240 (a geometry of the plurality of coupling teeth 1244 thereof) and due to a geometry of the outer race-facing side 1263 of the unidirectional coupling member 1260, the unidirectional coupling member 1260 slides along the inner surface of the outer race and is prevented from engaging the outer race 1240. The unidirectional coupling member 1260 is displaced radially toward the central axis (i.e., inwardly displaced) and/or is kept away from engagement with the inner surface of the outer race and the outer race 1240 rotates about the central axis X3 freely with respect to the inner race 1220 (i.e., the outer and inner races are not angularly coupled with each other). The inner race 1220 thus does not rotate about the central axis X3 and no friction couple is provided to the one-way tube-coupling bearing 1200 when used to equip the roller blind friction-creating assembly 1100.

For instance, the one-way bearing 1200 is arranged so that the first rotation R1 corresponds to the unwinding direction of the roller blind tube 52. The system could however easily be mounted in a reverse way (i.e., so that the first direction R1 would correspond to the winding direction of the roller blind tube 52). It could thus be conceived a roller blind system with a roller blind tube defining a mechanism-receiving cavity and first and second roller blind friction-creating assemblies according to the present disclosure, each of the first and second roller blind friction-creating assemblies comprising a one-way (or unidirectional) bearing. One of the one-way bearings could be arranged so that its first rotation R1 corresponds to the unwinding direction, while the other one-way bearing would be arranged so that its first rotation R1 would correspond to the winding direction.

Moreover, it is understood that the roller blind friction-creating assembly 100 according to the first embodiment, wherein a friction couple is provided to the tube-coupling bearing upon rotation of the roller blind tube in both the winding and unwinding directions can easily be converted into the roller blind friction-creating assembly 1100 according to the second embodiment, wherein a friction couple is provided to the tube-coupling bearing upon rotation of the roller blind tube in only one of the winding and unwinding directions (and vice-versa), the only component to be replaced in the roller blind friction-creating assembly being the tube-coupling bearing thereof.

It is thus understood that, for instance due to the absence of biasing member or mechanical connection between the outer race and the unidirectional coupling members, the one-way bearing can be easily manufactured and limits the risk of noise when in use. The use of the one-way bearing 1200 is obviously not limited to a roller blind friction-creating assembly, or even not limited to roller blind systems, and can be used to selectively angularly couple distinct elements depending on a rotation direction on one of the elements. Similarly, the use of the friction-creating assembly is not limited to a roller blind tube.

Several alternative embodiments and examples have been described and illustrated herein. The embodiments of the invention described above are intended to be exemplary only. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is understood that the invention may be embodied in other specific forms without departing from the central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind. The scope of the invention is therefore intended to be limited by the scope of the appended claims.

1. A one-way bearing having a central axis, comprising:
an inner race comprising an outer surface;
an outer race surrounding, considered in a plane transversal to the central axis, at least partially the inner race and comprising an inner surface, at least a portion of the inner surface being radially spaced apart from the outer surface of the inner race to define at least one coupling member-receiving chamber therebetween; and
at least one unidirectional coupling member provided in said at least one coupling member-receiving chamber;
wherein the outer surface of the inner race at least partially forms first and second tangential wall portions at least partially delimiting said at least one coupling member-receiving chamber;
wherein said at least one unidirectional coupling member engages with the inner surface of the outer race when the outer race is rotated about the central axis in a first direction, thus abutting one of the first and second tangential wall portions and rotating the inner race together with the outer race in the first direction; and
wherein said at least one unidirectional coupling member slides along the inner surface of the outer race when the outer race rotates about the central axis in a second direction opposed to the first direction, thus allowing a free rotation of the outer race with respect to the inner race,
said at least one unidirectional coupling member having an outer surface selectively engageable with the inner surface of the outer race when the outer race is rotated about the central axis.

2. The one-way bearing according to claim 1, wherein a plurality of indentations are formed along an entirety of a periphery of the inner surface of the outer race.

3. The one-way bearing according to claim 2, wherein said at least one unidirectional coupling member comprises an inner race-facing side and an opposed outer race-facing side forming at least partially the outer surface, and wherein a profile of the outer race-facing side of said at least one unidirectional coupling member corresponds substantially to a profile of the inner surface of the outer race.

4. (canceled)

5. The one-way bearing according to claim 3, wherein the outer surface of the inner race forms an actuating slope extending between the first and second tangential wall portions wherein the actuating slope is inclined relative to a tangential direction defined at a point equidistant from inner end portions of the first and second tangential wall portions.

6-8. (canceled)

9. The one-way bearing according to claim 1, wherein a plurality of coupling-member receiving chambers are defined between the inner surface of the outer race and the outer surface of the inner race, and wherein the plurality of coupling-member receiving chambers are regularly distributed along a periphery of the outer surface of the inner race.

10-11. (canceled)

12. The one-way bearing according to claim 1, wherein the inner race comprises first and second inner race members engaged with each other and axially delimiting said at least one coupling member-receiving chamber, and wherein the first and second inner race members are removably mounted to each other, said at least one unidirectional coupling member being encapsulated therebetween.

13. (canceled)

14. The one-way bearing according to claim 6, wherein the outer race is at least partially sandwiched between the first and second inner race members.

15. A roller blind friction-creating assembly for a roller blind system mountable to a roller blind support and comprising a roller blind tube rotatable about a tube longitudinal axis into opposed winding and unwinding directions, the friction-creating assembly comprising:
a support-mounting shaft system having a shaft axis and being fixedly mountable to the roller blind support;
a one-way bearing according claim 1, the outer race being angularly couplable with the roller blind tube and the inner race being rotatably mounted onto the support-mounting shaft system, the outer and inner races being rotatable together around the support-mounting shaft system in the first direction about the shaft axis upon rotation of the roller blind tube in one of the winding and unwinding directions; and
a friction-creating system mounted to the support-mounting shaft system and having at least one friction-creating surface contacting the one-way bearing;
wherein the friction-creating system provides a friction couple to the one-way bearing via said at least one friction-creating surface upon rotation of the inner and outer races of the one-way bearing in said first direction.

16. The friction-creating assembly according to claim 15, wherein the friction-creating system comprises a biasing member engaged with said support-mounting shaft system and with said at least one friction-creating surface to bias said at least one friction-creating surface towards the one-way bearing.

17. The friction-creating assembly according to claim 16, wherein the friction-creating system further comprises a friction adjuster engaged with the biasing member to adjust a value of a biasing force applied by the biasing member onto said at least one friction-creating surface, wherein the friction adjuster is mountable onto the support-mounting shaft in at least two longitudinal positions, thus allowing the biasing member to provide at least two distinct biasing force intensities, and wherein a plurality of biasing member-engaging portions are formed on the support-mounting shaft system, the biasing member-engaging portions being axially spaced apart from each other, the biasing member being selectively engageable with each one of said plurality of biasing member-engaging portions.

18.-20. (canceled)

21. The friction-creating assembly according to claim 15, comprising at least one friction-creating pad at least partially formed of rubber and forming said at least one friction-creating surface and angularly coupled to the support-mounting shaft system.

22. (canceled)

23. The friction-creating assembly according to claim 21, comprising first and second friction-creating pads forming respectively first and second friction-creating surfaces, the one-way bearing being arranged axially between the first and second friction-creating pads, wherein the inner race comprises first and second inner race members engaged with each other and axially delimiting said at least one coupling member-receiving chamber, the first and second friction-creating pads contacting respectively the first and second inner race members, wherein the first and second inner race members are removably mounted to each other, said at least one unidirectional coupling member being encapsulated therebetween and wherein the outer race is at least partially sandwiched between the first and second inner race members.

24-26. (canceled)

27. The friction-creating assembly according to claim 15, wherein the outer race of the one-way bearing is rotatable about the support-mounting shaft system and the inner race of the one-way bearing in a second direction opposed to the first direction about the shaft axis upon rotation of the roller blind in said other one of the winding and unwinding directions.

28. (canceled)

29. The friction-creating assembly according to claim 15, wherein the outer race further comprises flexible tube-engaging tongues protruding outwardly from an outer surface thereof that are dimensioned and shaped so that the one-way bearing substantially conforms to an inner surface of the roller blind tube when in use.

30. A roller blind friction-creating assembly for a roller blind system mountable to a roller blind support and comprising a roller blind tube rotatable about a tube longitudinal axis into opposed winding and unwinding directions, the friction-creating assembly comprising:
a support-mounting shaft system having a shaft axis and being fixedly mountable to the roller blind support;
a tube-coupling bearing having a first portion angularly couplable with the roller blind tube and a second portion rotatably mounted onto the support-mounting shaft system, the first and second portions being rotatable together around the support-mounting shaft system in a first rotating direction about the shaft axis upon rotation of the roller blind tube in one of the winding and unwinding directions; and
a friction-creating system mounted to the support-mounting shaft system and having at least one friction-creating surface contacting the tube-coupling bearing;
wherein the friction-creating system provides a friction couple to the tube-coupling bearing via said at least one friction-creating surface upon rotation of the first and second portions of the tube-coupling bearing in said first rotating direction.

31. The friction-creating assembly according to claim 30, wherein the friction-creating system comprises a biasing member engaged with said support-mounting shaft system and with said at least one friction-creating surface to bias said at least one friction-creating surface towards the tube-coupling bearing, wherein the friction-creating system further comprises a friction adjuster engaged with the biasing member to adjust a value of a biasing force applied by the biasing member onto said at least one friction-creating surface, wherein the friction adjuster is mountable onto the support-mounting shaft in at least two longitudinal positions, thus allowing the biasing member to provide at least two distinct biasing force intensities and wherein a plurality of biasing member-engaging portions are formed on the support-mounting shaft system, the biasing member-engaging portions being axially spaced apart from each other, the biasing member being selectively engageable with each one of said plurality of biasing member-engaging portions.

32-35. (canceled)

36. The friction-creating assembly according to claim 30, comprising first and second friction-creating pads at least partially formed of rubber and forming respectively said first and second friction-creating surfaces and angularly coupled to the support-mounting shaft system, the tube-coupling bearing being arranged axially between the first and second friction-creating pads.

37-38. (canceled)

39. The friction-creating assembly according to claim 30, wherein the tube-coupling bearing is a bidirectional bearing, the first and second portions being rotatable together about the shaft axis in opposed first and second rotating directions upon rotation of the roller blind tube respectively in the winding and unwinding directions.

40. The friction-creating assembly according to claim 30, wherein the tube-coupling bearing is a one-way tube-coupling bearing, the first portion of the tube-coupling bearing being rotated about both the support-mounting shaft system and the second portion of the tube-coupling bearing in a second rotating direction about the shaft axis upon rotation of the roller blind in said other one of the winding and unwinding directions wherein said at least one friction-creating surface is at least one of radially and axially spaced apart from the first portion of the tube-coupling bearing.

41-43. (canceled)

44. A roller blind system comprising:
a roller blind tube having a tube longitudinal axis and defining a mechanism-receiving cavity; and
a roller blind friction-creating assembly according to claim 30 at least partially arranged in the mechanism-receiving cavity, wherein the first portion of the tube-coupling bearing is angularly coupled with an inner surface of the roller blind tube at least partially delimiting the mechanism-receiving cavity.
